(19) United States
(12) Patent Application Publication
(10) Pub. No.: US 2026/0181710 A1
(43) Pub. Date: Jun. 25, 2026

(54) BASEBAND UNIT MAPPING FOR SATELLITE-BASED DIRECT TO CELLULAR COMMUNICATIONS

(71) Applicant: AT&T Intellectual Property I, L.P., Atlanta, GA (US)

(72) Inventors: Yupeng Jia, South Pasadena, CA (US); Hongyan Lei, Plano, TX (US); Venson Shaw, Kirkland, WA (US)

(21) Appl. No.: 19/000,664

(22) Filed: Dec. 23, 2024

(51) Int. Cl. H04W 76/10; H04W 84/06

(52) U.S. Cl. CPC H04W 76/10; H04W 84/06

(57) ABSTRACT

A processing system including at least one processor deployed in a non-terrestrial network node may identify a plurality of available baseband units of a cellular network and may select a first baseband unit from among the plurality of available baseband units via a machine learning model implemented by the processing system. The processing system may then establish a fronthaul connection between the non-terrestrial network node and the first baseband unit, where the fronthaul connection is via a first wireless link between the non-terrestrial network node and the first baseband unit. The processing system may further forward data traffic for at least one endpoint device via the fronthaul connection and via at least a second wireless link between the non-terrestrial network node and the at least one endpoint device.

The present disclosure relates generally to cellular network operations, and more particularly to methods, non-transitory computer-readable media, and apparatuses for establishing a fronthaul connection between a non-terrestrial network node and a first baseband unit that is selected from among a plurality of available baseband units via a machine learning model implemented by the non-terrestrial network node.

### BACKGROUND

Modern society may increasingly expect continuous network connectivity at any time of the day and day of the week. In many cases, a loss of connectivity may be considered an emergency. For example, first responders, governmental entities, medical facilities, home medical devices, and others may rely on consistent connectivity in order to function. In addition, small cells and wireless access points are increasingly prevalent. However, wireless access points and small cells may still assume access is available to wired infrastructure capable of supporting high data rates, which may still remain infeasible in many areas of the world.

### SUMMARY

In one example, the present disclosure discloses a method, computer-readable medium, and apparatus for establishing a fronthaul connection between a non-terrestrial network node and a first baseband unit that is selected from among the plurality of available baseband units via a machine learning model implemented by the non-terrestrial network node. For example, a processing system including at least one processor of a non-terrestrial network node may identify a plurality of available baseband units of a cellular network and may select a first baseband unit from among the plurality of available baseband units via a machine learning model implemented by the processing system. The processing system may then establish a fronthaul connection between the non-terrestrial network node and the first baseband unit, where the fronthaul connection is via a first wireless link between the non-terrestrial network node and the first baseband unit. The processing system may further forward data traffic for at least one endpoint device via the fronthaul connection and via at least a second wireless link between the non-terrestrial network node and the at least one endpoint device.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for establishing a fronthaul connection between a non-terrestrial network node and a first baseband unit that is selected from among the plurality of available baseband units via a machine learning model implemented by the non-terrestrial network node; and

FIG. 3 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for establishing a fronthaul connection between a non-terrestrial network node and a first baseband unit that is selected from among a plurality of available baseband units via a machine learning model implemented by the non-terrestrial network node. To illustrate, examples of the present disclosure provide multiple satellite radio unit to baseband unit (BBU) mappings through an open interface to facilitate satellite-based cellular network communications and to improve the user experience when a satellite connectivity is activated. In particular, examples of the present disclosure include sharing of BBUs among multiple satellite radio units, which may reduce the hardware investment to expand satellite-enhanced cellular network service and coverage, and which may also offer performance improvements. For instance, examples of the present disclosure may simplify cellular network satellite coverage expansion via provisioning of satellite-based radio units, without necessarily increasing the number of BBU. In addition, examples of the present disclosure may enable the use of low-earth orbit (LEO) satellites, where BBUs associated with the LEO satellites may change frequently. In one example, the present disclosure may integrate artificial intelligence (AI) and/or machine learning (ML)-based models into the satellite network architecture to enhance network intelligence, automation, and decision making capabilities. In one example, the AI/ML-based model sizes may be adjusted to facilitate intra- and inter-satellite communications.

Satellites offer great potential for telecommunications around the globe. For example, satellites may offer complementary connectivity for cellular networks (e.g., as an alternatively or in addition to terrestrial cell sites) in unserved or underserved areas. Their unique capabilities can also expand the reach of 5G networks (or future 6G networks and beyond) into new use cases. The success of cellular-to-satellite communication may depend heavily on the deployment of massive satellite constellations. Inter-satellite links (ISLs) may support the satellite constellation(s) with inter-satellite communications. For example, ISLs provide connectivity in a multi-hop scenario for satellites without connectivity to a ground station. In addition, in accordance with the present disclosure ISLs and ground links enable dynamic advanced network topologies through the incorporation of AI/ML models within the satellites to select and to adapt the satellite to BBU mappings (including single or multiple satellite to multiple BBU mappings).

Examples of the present disclosure incorporate AI/ML into satellites to select and coordinate satellite radio unit (RU) to BBU mappings. By deploying multiple satellite radio units in strategic locations connecting to a single BBU or multiple BBUs (e.g., each satellite serving a relatively small area), cellular networks may effectively offload traffic from a congested terrestrial cell site to a satellite, or from a congested satellite to one or more less busy satellites. To illustrate, on a given satellite, a machine learning model (MLM) in accordance with the present disclosure may facilitate the mapping between satellite radios and BBUs by analyzing network data to provide insights for optimizing network configurations (adjusting the satellite-BBU mapping topology) and/or predicting the potential offloading timing and condition(s).

Notably, this architecture may also better handle endpoint device service continuity. For instance, considering a tracking area update (TAU) for an endpoint device, there could be tens or hundreds of satellite radio units able to serve one tracking area. During the TAU procedure, the network may update the endpoint devices' location information and may adjust the endpoint device's routing accordingly. However, to provide uninterrupted voice calls, data sessions, and other services over distances involved in satellite communications may be impractical without particularized machine learning, particularly where some of the satellites may be non-stationary, and where a potential footprint may overlap with tens or hundreds of terrestrial cell sites. For instance, an endpoint device may maintain synchronization with a core network during satellite connectivity and may monitor for a tracking area code (TAC) within the system information broadcast. In one example, the cellular network may use a paging procedure over the tracking area for mobile terminated data. Notably, the tracking area size can be large or small. Within a BBU for multiple satellites, or within a satellite (multiple satellite beam scenarios), satellite MLM insights may be shared with endpoint devices to provide visibility of network coverage conditions over larger areas (e.g., beyond a serving terrestrial cell site and adjacent cell sites). In addition, collaboration among on-satellite MLM insights may improve user experience and network performance, while reducing the overall the processing power consumed by MLM operations across a plurality of satellites sharing data.

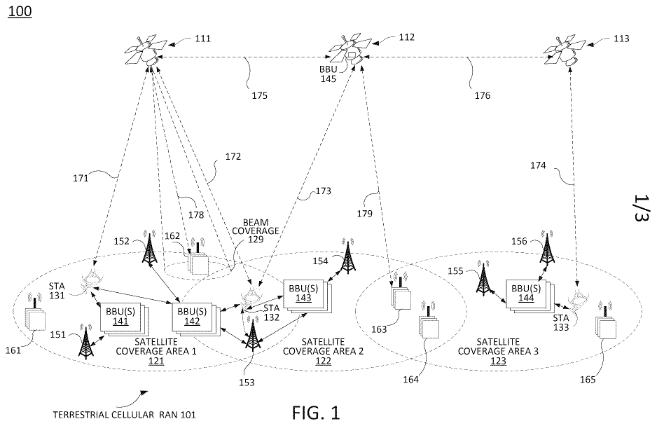

Multiple satellite RU to multiple BBU mappings in non-terrestrial networks (NTNs) (e.g., satellite networks) in accordance with the present disclosure enable efficient resource utilization, improved coverage, and enhanced performance in idle and connected mode, contributing to a robust and scalable cellular network (or cellular/NTN hybrid network) capable of meeting evolving user demands. The present architecture can scale a cellular network more efficiently, and may further simplify network expansion. In addition, disaggregation of satellite radio units from cellular baseband units enable easier implementation of advanced features, such as coordination between satellite radio units, interference mitigation, beamforming, and so forth. It should also be noted that the term “non-terrestrial network” (NTN) represents a plethora of connection scenarios, including satellite-based communications via airborne stations, air-to-ground or uncrewed aerial vehicles (UAV) flight control, and so forth. Thus, examples of the present disclosure are not limited to satellite communications but may also be expanded to air to ground or UAVs, balloons, etc. These and other aspects of the present disclosure are discussed in greater detail below in connection with the examples of FIGS. 1-3.

FIG. 1 illustrates an example network, or system 100 in which examples of the present disclosure may operate. In one example, the system 100 includes a terrestrial cellular radio access network (RAN) 101 (e.g., a 5G RAN, a 5G/4G/Long Term Evolution (LTE) hybrid RAN, an evolved Universal Terrestrial Radio Access Network (eUTRAN), or the like). In one example, the terrestrial cellular radio access network (RAN) 101 may comprise a cloud RAN. For instance, a cloud RAN is part of the 3rd Generation Partnership Project (3GPP) 5G specifications for mobile networks. As part of the progression of mobile/cellular networks towards 5G, a cloud RAN may be coupled to a 5G core network and/or to an Evolved Packet Core (EPC) network until new cellular core networks are deployed in accordance with 5G specifications.

To further illustrate, the terrestrial cellular RAN 101 may include a plurality of cell sites 151-156, which may each comprise a radio unit (RU) or remote radio head (RRH) of a cellular base station, e.g., a gNodeB, or gNB. In addition, the terrestrial cellular RAN 101 may include a plurality of baseband units (BBUs) 141-144, which may be associated with one or more cellular base stations (e.g., gNBs). For instance, the BBUs 141-144 may represent one or more distributed units (DUs) and/or one or more centralized units (CUs) assigned to one or more cellular base stations and/or cell sites. It should be noted that in accordance with an Open-Radio Access Network (ORAN) architecture, CUs and DUs may be disaggregated and deployed on computing resources at different physical locations. However, for ease of illustration, these components are represented collectively as BBUs (e.g., BBUs 141-144, illustrated as BBU pools).

In particular, a BBU pool may be located at distances as far as 20-80 kilometers or more away from the antennas/remote radio heads of cell sites that are serviced by the BBU pool. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less. Although cloud RAN infrastructure may include distributed RRHs and centralized baseband units, a heterogeneous network may include cell sites where RRH and BBU components remain co-located at the cell site. For instance, cell site 153 may include RRH and BBU components. Thus, cell site 153 may comprise a self-contained “base station.”

FIG. 1 also illustrates various endpoint devices, e.g., user equipment (UEs) (which for ease of illustration are shown as groups or clusters of endpoint devices 161-165, where it should be understood that such endpoint devices 161-165 with each cluster may be in a range of different (but nearby) geographic locations rather than precisely co-located). Endpoint devices 161-165 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing devices (broadly, “an endpoint device”). In one example, endpoint devices 161-165 may each be equipped with one or more directional antennas, or antenna arrays (e.g., having a half-power azimuthal beamwidth of 120 degrees or less, 90 degrees or less, 60 degrees or less, etc.), e.g., multiple input-multiple output (MIMO) antenna(s) to receive multi-path and/or spatial diversity signals. Some or all of the endpoint devices 161-165 may also include a gyroscope and compass to determine orientation(s), a global positioning system (GPS) receiver for determining a location (e.g., in latitude and longitude, or the like), and so forth. In one example, some or all of the endpoint devices 161-165 may include a built-in/embedded barometer from which measurements may be taken and from which an altitude or elevation of the respective endpoint device may be determined. In one example, some or all of the endpoint devices 161-165 may also be configured to determine location/position from near field communication (NFC) technologies, such as Wi-Fi direct and/or other Institute of Electrical and Electronics Engineers (IEEE) 802.11 communications or sensing (e.g., in relation to beacons or reference points in an environment), IEEE 802.15 based communications or sensing (e.g., “Bluetooth™,” “ZigBee™,” etc.), and so forth.

As further illustrated in FIG. 1, the system 100 includes non-terrestrial network (NTN) nodes 111-113 (e.g., satellites), each having a respective satellite coverage areas 1-3 (121-123). The NTN nodes 111-113 together with ground stations (STA) 131-133 may comprise a non-terrestrial network (NTN), e.g., a satellite network. Notably, 3GPP standards (e.g., release 17 and beyond) expand the concept of cellular services over non-terrestrial networks in which satellites or other NTN nodes may include 3GPP new radio (NR) compliant technologies. For instance, in the example of FIG. 1, satellites 111-113 may each include remote radio heads (RRHs) and/or radio units (RUs), e.g., according to O-RAN definitions. In some examples, satellites or other NTN nodes may also include BBUs, DUs, and/or CUs. For instance, in FIG. 1, satellite 112 may include a BBU 145.

Each of the satellites 111-113 may have one or more feeder links 171-174) to one or more ground stations (e.g., also referred to as satellite gateways or satellite access nodes), e.g., ground stations (STAs) 131-133. In addition, the satellites 111-113 may have inter-satellite links (ISLs) 175 and 176 as further illustrated in FIG. 1. In accordance with the present disclosure, satellites 111-113 may each provide cellular network connectivity services to endpoint devices in connection with terrestrial cellular RAN 101. For instance, satellite 111 may serve one or more endpoint devices 162 via beam coverage 129. The connections for endpoint devices 162 to satellite 111 may be referred to as “service links” (such as service link 178). Notably, satellite 111 may be capable of providing beam coverage anywhere within satellite coverage area 1 (121). However, to support performance (e.g., data rates, throughput, latency, etc.) that is the same or as close as possible to terrestrial cellular service, more focused directional beams may customarily be used (e.g., such as illustrated by beam coverage 129). It should be understood that endpoint devices 161, 163-165, etc. may similarly obtain service links with any of satellites 111-113 for which the respective endpoint devices are within an associated one of satellite coverage areas 1-3 (121-123), and that the corresponding one of satellites 111-113 may provide a direction beam to support the service links for one or a plurality of such endpoint devices. Similarly, any of endpoint devices 161-165 may attach to terrestrial cellular network 101 via any of the cell sites 151-156 that is/are within communication range. For ease of illustration, the communication ranges(s) of cell sites 151-156, e.g., cell footprints, and links between endpoint devices 161-164 and cell sites 151-156 are omitted from FIG. 1.

It should be noted that FIG. 1 illustrates two architecture modes for extending cellular services across NTN air interfaces to endpoint devices. In particular, in a non-regenerative mode, also referred to as a transparent mode, the uplink may involve a satellite radio unit (RU) or RRH receiving uplink data traffic from endpoint devices via service links, and forwarding the data traffic to a ground station via a feeder link, where the ground station may further pass the data traffic to a baseband unit. For instance, in one example, satellite 111 may receive data traffic from one of the endpoint devices 162 via service link 178, and may retransmit the data traffic via feeder link 171 to ground station 131. In turn, ground station 131 may pass the data traffic to one of BBUs 141 or 142. In another example, satellite 111 may retransmit the data traffic via feeder link 172 to ground station 132, where ground station 132 may pass the data traffic to one of the BBUs 142 or 143. The uplink may follow a similar pattern in reverse. For example, uplink data for one of the endpoint devices 162 may be received at one of the BBUs 141 or 142, e.g., from a cellular core network element (such as a user plane function (UPF), etc.) and may be forwarded to ground station 131 for transmission to satellite 111 via feeder link 171. In another example, the uplink data may be received at one of the BBUs 142 or 143, e.g., from a cellular core network element, and may be forwarded to ground station 132 for transmission to satellite 111 via feeder link 172. In either case, the satellite 111 may retransmit the data traffic via service link 178 to the one of the endpoint devices 162.

In a regenerative model, the entire RAN infrastructure (or at least an RU and DU) may be deployed to a NTN node. For instance, FIG. 1 illustrates that satellite 112 may include a baseband unit 145 (e.g., in addition to an RU/RRH (not shown)). In this case, BBU 145 may establish links/interfaces to cellular core network components (e.g., a UPF, an access management function (AMF), etc.) via ground station 132. While the data flow for serving one or more of the endpoint devices 163 may be similar to the transparent mode, the demarcation points for different RAN and cellular core links/interfaces are different. To further illustrate, satellite 112 may receive uplink data traffic from one of the endpoint devices 163 via service link 179. BBU 145 may process the data traffic and may retransmit the data traffic via feeder link 173 to ground station 132. In turn, ground station 132 may pass the data traffic to a cellular core network element/network function, e.g., UPF, or for management traffic an AMF, etc. Similarly, ground station 132 may receive uplink data traffic, e.g., from a cellular core network element, and may transmit the data traffic to satellite 112 (e.g., to BBU 145). BBU 145 may process the data traffic and may retransmit the data traffic to an intended one of the endpoint devices 132 via feeder link 179.

It should be noted that BBU 145 may process data traffic not only for endpoint devices 163 (and/or others) having service links to satellite 112, but also for other endpoint devices having service links via other satellites. For instance, in one example, satellite 111 may provide cellular network access to one or more of the endpoint devices 162, e.g., via feeder link 178. However, satellite 111 may associate itself with BBU 142 rather than a terrestrial-based BBU. In this case, uplink data traffic for the endpoint device(s) 162 may be received via service link 178 and retransmitted via inter-satellite link (ISL) 175 to BBU 145. BBU 145 may process the data traffic and in one example may retransmit the data traffic via feeder link 173 to ground station 132 (e.g., for onward forwarding to a cellular core network). Uplink data traffic for the endpoint device(s) 162 may follow a similar path in reverse. The use of regenerative mode and NTN-based BBUs may enable some satellites to continue to provide usable service links to endpoint devices even when a ground station is not visible or within communication range of such satellite, e.g., if the satellite is still able to maintain an ISL with another satellite. In addition, an NTN-based BBU, such as BBU 145, may also enable routing of data traffic between certain endpoint devices without the need to enter or traverse the cellular core network. This can be particularly advantageous where the routing of data traffic over feeder links can be avoided, e.g., resulting in substantial latency savings, etc. For instance, if one of the endpoint devices 163 is communicating with another one of the endpoint devices 163, BBU 145 may hairpin the communication through satellite 112 without relay to ground station 132. It should be noted that this type of situation may occur frequently where users may be travelling in a group in the wilderness or traveling on a ship where satellite connectivity may be the only option or the most viable option to maintain connectivity to a cellular network, and where the users may often use their endpoint devices to maintain in voice and text contact when out of direct face-to-face communication range (such as at opposite ends of a ship, when a mile or more apart on a trail, etc.).

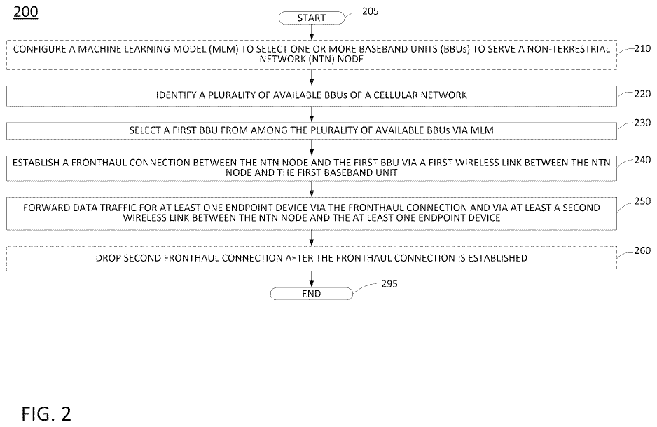

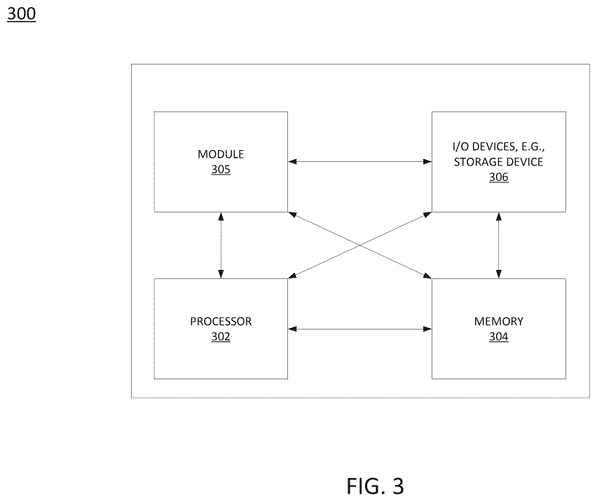

As noted above, the present disclosure further provides for intelligent mapping of NTN nodes to baseband units. For instance, as illustrated in FIG. 1, satellite 111 may establish feeder links with either of ground stations 131 or 132, via which satellite 111 (e.g., a radio unit/RRH thereof) may be associated with one of the BBUs 141 or 142. In addition, satellite 111 may maintain an ISL 175 with satellite 112 by which it may be associated with BBU 145. In this regard, satellite 111 (and similarly satellites 112 and 113) may comprise all or a portion of a computing system, such as computing system 300 depicted in FIG. 3, and may be configured to perform one or more steps, functions, and/or operations in connection with examples of the present disclosure for establishing a fronthaul connection between a non-terrestrial network node and a first baseband unit that is selected from among a plurality of available baseband units via a machine learning model implemented by the non-terrestrial network node, such as illustrated and described in connection with the example method 200 of FIG. 2.

In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

To further illustrate, in one example, satellite 111 may comprise a machine learning model (MLM) that is trained/configured to select at least one BBU of a plurality of BBUs via which the satellite 111 is to establish and/or maintain fronthaul connections (e.g., RRH/RU to BBU/DU connections). In various examples the fronthaul connections may be established over feeder links or inter-satellite links, such as feeder links 171 and 172 and/or ISL 175 for satellite 111. In particular, the MLM may be configured to process an input or a set of inputs (e.g., an input vector) including the identities/a list of various available BBUs, and to generate an output comprising a selection of one or more of the BBUs to be associated with the host NTN node (e.g., in the present example, satellite 111). In one example, the input vector may further include current (e.g., most recent) load information of the available BBUs and/or the subject NTN node (e.g., satellite 111). For instance, such a MLM may be trained to account for historic trends, but at any given time, an optimal NTN node to BBU assignment may be more likely to be achieved when particularly taking into account the most recent/most up to date load information. Accordingly, in one example, this may be incorporated into the input vector at runtime (e.g., when making BBU assignment decisions/recommendations for satellite 111 or the like). However, in another example, the network load information may be fully accounted for within the training of MLM. For instance, the MLM may be retrained periodically or otherwise, or may be updated on an ongoing basis, e.g., via reinforcement learning (RL) or the like, to keep the MLM current.

In accordance with the present disclosure, the load information may include a number of NTN nodes already attached to each of the plurality of available BBUs, a number of endpoint devices being served via each of the plurality of available BBUs, a data traffic volume via each of the plurality of available BBUs (e.g., over one or more lookback time windows, including overall traffic volume, peak and average data rate, moving averages, weighted moving averages, etc.), and/or a remaining available capacity of each of the plurality of available BBUs, and so forth. In one example, the load information and/or the input vector may further comprise information regarding endpoint device types of endpoint devices being served via each BBU, the applications being used, or other endpoint device details, trajectories of endpoint devices or groups of endpoint devices (e.g., a group of eight hikers in a remote wilderness, a ship on an ocean voyage with 80 crew and/or 500 passengers, etc., may be “grouped” based on commonality of movement over an initial observation period, for example), and so forth. In various examples, the input vector may further include load information of the satellite 111, a trajectory of the satellite 111 (if non-stationary), locations of one or more available ground stations, BBU to ground station connectivity information (e.g., which BBUs may be reached via with ground stations and/or any distances, latency, or other performance factors associated therewith, etc.).

Thus, from any or all of these input factors, or the like, and based upon model training using historic data patterns, a trained MLM of satellite 111 may thus generate an output comprising a recommended set of one or more BBUs to serve and be associated with satellite 111. In one example, training data may comprise labeled records of satellite to BBU assignments. For instance, in one example, the labels may indicate whether the assignment was “successful” or “unsuccessful.” To illustrate, users may provide feedback via endpoint devices of whether the service was acceptable or not acceptable. Alternatively, or in addition, a network operator may set one or more thresholds and/or may use one or more formulas to determine whether an assignment was successful or not. For instance, if a call drop rate, a call block rate, latency metrics, throughput metrics, or the like fail to meet one or more performance thresholds/benchmarks, the assignment may be labeled as unsuccessful (otherwise a label of “successful” may be applied). In still another example, the labels may be on a scale, such as 1-5, 1-10, 0-10, 0-100, etc. indicating a level or percentage of success (or lack thereof). For instance, a formula may be based on one or more of the foregoing factors (e.g., call drop rate, call block rate, latency, throughput, etc.), where an output “score” or value may indicate the relative level of success. This label may then be used in conjunction with corresponding records data regarding the assignment of one or more NTN nodes to one or more base stations as training data for MLM training.

It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

To further illustrate, MLMs of the present disclosure may include an ML-based generative model, such as a language model, e.g., a “large language model” (LLM). For instance, a ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. For instance, a generative model, such as one of the foregoing, may be trained/configured to generate NTN node to BBU mappings in view of various factors, such as: BBU load and/or NTN load, temporal factors (e.g., time of day, day of the week, season of the year, etc.), NTN node trajectory, locations of one or more available ground stations, BBU to ground station connectivity information (e.g., which BBUs may be reached via with ground stations and/or any distances, latency, or other performance factors associated therewith, etc.), and so forth.

In one example, the present disclosure may fine-tune a LLM to provide high-level instructions for radio access network (RAN), cellular network, and/or satellite network-specific issues. In addition, in one example, the present disclosure may further enhance such a fine-tuned MLM to provide concrete, actionable instructions, e.g., NTN node to BBU assignments/mappings. For instance, a generative LLM of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store, as well as current BBU and/or NTN node load information (e.g., associated with satellite 111 and/or any one or more of BBUs 141 or 142, etc.). In one example, input data for such a LLM-based generative model may include converting categorical or numerical data to text form, as well as vectorization of textual data to vectors (e.g., via word2vec, doc2vec, Global Vectors for Word Embedding (GloVe), or the like, using n-grams, and so forth). In one example, tailored prompts may be used in connection with a generative MLM of the present disclosure, e.g., to obtain outputs that may comprise instructions in useable format with respect to other network functions, such as outputs formatted for 3GPP/5G standards compliant communications, IEEE 802.11 standards compliant communications, or the like. For instance, the prompt may explicitly request a selection of one or more BBUs from among a plurality of available BBUs, e.g., where the prompt may list the available BBUs and/or where further information about the BBUs, e.g., load information, etc. may be obtained for appending as RAG content.

In one example, satellite 111 may have direct awareness of its own load information (e.g., by maintaining records of such metric(s)). In addition, satellite 111 may obtain BBU load information of one or more available BBUs from the terrestrial cellular RAN 101. For instance, satellite 111 may maintain at least one existing feeder link while evaluating an updated NTN node to BBU mapping. Thus, for example, satellite 111 may have an existing connection to BBU 141 via feeder link 171 and ground station 151. Satellite 111 may therefore obtain load information for one or more of BBUs 141 via this feeder link 171. In addition, satellite 111 may also obtain load information regarding one or more of BBUs 142, 143, etc. from BBUs 141 via feeder link 171. For instance, BBUs in terrestrial cellular RAN 101 may communicate with each other to share load information or other information (e.g., via terrestrial/wired links and/or via wireless backhaul via any of cell sites 151-153 or the like, and so forth). As such, while satellite 111 may apply input data to its dedicated MLM to obtain a new NTN node to BBU mapping, it may maintain the feeder link 171 to ground station 131 and one or more BBUs 141. Thus, the new NTN node to BBU mapping may include establishing feeder link 172 to ground station 132 and one of the BBUs 143. In one example, the new NTN node to BBU mapping may also include the existing one of the BBUs 142, in which case feeder link 171 may be maintained. However, in another example, the new NTN node to BBU mapping may also include the existing one of the BBUs 142, in which case feeder link 171 may be dropped when feeder link 172 is established.

In one example, satellite 111 may continue to gather performance data (which may include load information and/or other performance factors) to determine whether selected mappings of satellite 111 to BBUs are “successful” /“unsuccessful” or the like, e.g., where satellite 111 may use the performance data as labels for mapping records for MLM training/retraining (e.g., automated machine learning (autoML). Alternatively, or in addition, the terrestrial cellular RAN 101 and/or cellular carrier network comprising the terrestrial cellular RAN 101 may gather user or endpoint device feedback regarding the acceptability of service via satellite service links, which may be similarly used to label mapping records.

It should be noted that FIG. 1 illustrates (and the foregoing describes) just several examples in accordance with the present disclosure. Thus, it should be appreciated that other, further, and different examples may readily be devised in accordance with the present disclosure. As just one example, a satellite or other NTN nodes may maintain feeder links at all times with a plurality of ground stations, e.g., for redundancy purposes and for fast remapping of NTN nodes to BBUs. For instance, even if a feeder link is not currently designated to be used for cellular data traffic, a satellite or other NTN nodes may maintain the feeder for fast reestablishment of NTN node to BBU pairing(s) for cellular data traffic and/or for other purposes, such as for satellite management (e.g., changing solar array orientations, power management, diagnostic reporting, etc.). In another example, the system 100 may alternatively or additionally include NTN nodes of varying types, such as balloons, UAVs, etc.

As noted above, the MLM may be retrained periodically or otherwise, or may be updated on an ongoing basis, e.g., via reinforcement learning (RL) or the like, to keep the MLM current. In one example, MLMs of different NTN node may account for the selections of other MLMs/other NTN nodes. For instance, the MLMs may be trained in accordance with an objective function to maximize performance in a tracking area. Thus, instead of a MLM selecting a NTN node to BBU mapping with a singular focus to maximize performance of its own NTN node, the MLM may account for the performance metrics of other NTN nodes that may serve the same overlapping or partially overlapping areas. For example, satellites 111-113 may share their NTN node to BBU mappings along with the corresponding performance data, where each may apply the same or similar objective functions that attempt to maximize overall performance across the several satellites 111-113. In still another example, BBUs may be provided with similar MLMs which may be trained to generate recommended BBU to satellite mappings. For instance, BBUs may be equipped to solicit connections/associations with NTN nodes, or to accept or reject connection/association requests from NTN nodes, based upon the recommendations/outputs of respective BBU-deployed MLMs, which may be trained using the same or similar training data as discussed above, e.g., BBU load and/or NTN node load information, NTN node trajectories, etc.

It should be noted that in some examples, the satellite network (e.g., satellites 111-113 and ground stations 131-133) may be controlled and/or operated by one or more entities that are different from the terrestrial cellular RAN and/or a cellular core network associated therewith. As such, in different examples, satellite access components (e.g., satellites 111-113 and ground stations 131-133) may be designated as trusted or untrusted, such that data ingress and egress to the cellular core network may be via shared gateway, a security gateway (SeGW), and/or a non-3GPP inter-working function (N3IWF) (e.g., a non-cellular network interworking function). In particular, a N3IWF enables protocol data unit (PDU) session establishment via a UPF for endpoint devices connecting to external networks beyond the cellular core via trusted and untrusted non-cellular (e.g., non-3GPP) access networks. These can include IEEE 802.11/Wi-Fi networks, and in accordance with the present disclosure, may further include satellite access networks. In this regard, it should also be noted that the terrestrial cellular RAN 101 may also interface with one or more cellular core networks, some or all of which may be operated by a different entity other than the terrestrial cellular RAN 101. For example, the terrestrial cellular RAN 101 may comprise a private cellular network or a RAN of a peer cellular network. For instance, in one example, terrestrial cellular RAN 101 may be made available by a host mobile network operator (MNO) that provides for shared use of terrestrial cellular RAN 101 by one or more other MNOs, e.g., those operating one or more cellular core networks.

In addition, the foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For instance, intermediate devices and links between cell sites 151-156 or BBUs 141-144 and other components of system 100 are omitted for clarity, such as additional routers, switches, gateways, and the like. Likewise, links to one or more cellular core networks are also omitted for ease of illustration. Thus, these and other modifications are all contemplated within the scope of the present disclosure.

FIG. 2 illustrates a flowchart of an example method 200 for configuring a establishing a fronthaul connection between a non-terrestrial network node and a first baseband unit that is selected from among a plurality of available baseband units via a machine learning model implemented by the non-terrestrial network node, in accordance with the present disclosure. In one example, steps, functions and/or operations of the method 200 may be performed by a device as illustrated in FIG. 1, e.g., a processing system of a NTN node, such as a satellite or the like, or collectively via a plurality devices in FIG. 1, such as a NTN node in conjunction with one or more other NTN nodes, one or more BBUs (e.g., DU(s) and/or CU(s)), one or more ground stations (e.g., NTN gateways or satellite gateways), and so forth. In one example, the steps, functions, or operations of method 200 may be performed by a computing device or system 300, and/or a processing system 302 as described in connection with FIG. 3 below. For instance, the computing device or system 300 may represent at least a portion of device or system deployed in a cellular network that is configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system, such as processing system 302. The method 200 begins in step 205 and may proceed to optional step 210 or to step 220.

At optional step 210, the processing system (e.g., deployed in a NTN node, such as a satellite, a LEO satellite, a UAV (e.g., including a balloon, a drone, or the like), etc.) may configure a machine learning model (MLM) to select one or more baseband units (BBUs) to serve the NTN node (e.g., to pair with/associate with a RRH or RU of the NTN node so as to comprise a disaggregated cellular base station). For instance, the MLM may be configured to generate an output comprising a selected BBU in response to an input vector comprising load information associated with the plurality of available BBUs. To further illustrate, step 210 may include training the MLM with labeled examples and/or fine tuning the MLM with BBU load information (and in some examples with additional features, such as NTN load information, endpoint device characteristics (e.g., device type, status, etc.), and so forth). For instance, in one example, the MLM may comprise a generative MLM as discussed above, such as a language model, e.g., a LLM, a GAN, and so forth. In still other examples, the MLM (e.g., a generative MLM) may comprise a CNN, a RNN, a decision tree, and so forth. In one example, the labeled example (e.g., training data) may comprise labeled records of satellite to BBU assignments. For instance, in one example, the labels may indicate whether the assignment was “successful” or “unsuccessful” based on user feedback and/or one or more thresholds or formulas based on one or more performance indicators.

At step 220, the processing system identifies a plurality of available BBUs of a cellular network. In one example, the identifying may be triggered by a tracking area update (TAU) or a threshold number of TAUs by endpoint devices indicating that they are entering a new tracking area that may be served by the NTN node. For instance, the NTN node may attach itself to a new tracking area such that endpoint devices may more easily move between a terrestrial base station service and NTN/satellite service when moving through a tracking area (e.g., NTN/satellite service may be used intermittently while driving through a remote area that still has some available terrestrial cellular service). In one example, the identifying may be triggered when the NTN node is anticipated to be losing a viable connection to a current BBU (e.g., via a ground station providing access to the current BBU). In one example, the plurality of available BBUs may include one or more BBUs deployed in other NTN nodes. In one example, the plurality of available BBUs may also include a BBU that is a component of the NTN node itself.

At step 230, the processing system selects a first BBU from among the plurality of available BBUs via a MLM implemented by the processing system (such as the MLM that may be trained at optional step 210). As noted above, in one example, the first BBU may comprise a centralized unit (CU) and a distributed unit (DU). In addition, the CU and the DU may comprise at least a portion of a cellular base station (e.g., the NTN node may comprise an RU, where the CU, DU, and RU together may comprise a disaggregated base station). As noted above, the MLM may be configured to generate an output comprising a selected BBU in response to an input vector comprising load information associated with the plurality of available BBUs. In one example, the input vector may comprise the plurality of available BBUs, e.g., a list of the plurality of available BBUs. For instance, in an example in which the MLM comprises a language model, the list of available baseband units may be included in a prompt content. An example prompt may be: “select a best baseband unit from among the following baseband units: [LIST].” In one example, the prompt may further include appended information, such as “this is my trajectory: [trajectory information],” “here is the most recent load information for each of the available baseband units: [load information].” In one example, step 230 may include applying a retrieval augmented generation (RAG) content as supplemental prompt content (e.g., in the case in which the MLM may comprise a language model, such as a LLM).

As discussed above, the load information may include a number of NTN nodes attached to each of the plurality of available BBUs, a number of endpoint devices being served via each of the plurality of available BBUs, a data traffic volume via each of the plurality of available BBUs, a remaining available capacity of each of the plurality of available BBUs, and so forth. In various examples, the load information may also include endpoint device types served, the applications being used, or other endpoint device details, trajectories of endpoint devices or groups of endpoint devices (e.g., a group of eight hikers in a remote wilderness, a ship on an ocean voyage with 12 crew and/or 20 passengers, etc., may be “grouped” based on commonality of movement over an initial observation period, for example), and so on. In various examples, the input vector may further include one or more of: load information of the NTN node, a trajectory of the NTN node (e.g., only if the non-terrestrial network node is mobile and/or has a non-fixed orbit), locations of one or more satellite ground stations, latencies between the one or more satellite ground stations and respective ones of the plurality of available BBUs, distances between the one or more satellite ground stations and the respective ones of the plurality of available BBUs, and/or the like.

In one example, the load information may be obtained from a second BBU via a second fronthaul connection with the NTN node. For example, the NTN node may maintain the second fronthaul connection between the NTN node and the second BBU (e.g., before attaching to a new BBU, the NTN node may maintain the previous association to continue to receive management data enabling it to select a next/new BBU (and in some cases, to continue to serve endpoint devices via the second BBU until a new fronthaul connection to another BBU is established)). In addition, the BBUs may communicate with each other and share load information, which may be passed to the NTN node by the second BBU. In addition, in on example, step 230 may include selecting two or more BBUs including the first BBU from among the plurality of available BBUs via the MLM.

At step 240, the processing system establishes a fronthaul connection between the non-terrestrial network node and the first BBU, where the fronthaul connection is via a first wireless link between the non-terrestrial network node and the first BBU. In one example, the fronthaul connection may include a wireless feeder link between the non-terrestrial network node and a satellite ground station. In addition, the fronthaul connection may further include a terrestrial communication link between the first baseband unit and the satellite ground station. In one example, the fronthaul connection may be in accordance with an Open Radio Access Network (O-RAN) fronthaul protocol. In another example, the fronthaul connection may be via an inter-satellite link (ISL). For instance, the selected first BBU may be deployed in another NTN node. In addition, in an example, in which two or more BBUs are selected at step 230, step 240 may include establishing two or more fronthaul connections between the NTN node and the two or more BBUs, via two or more wireless links between the NTN node and the two or more BBUs.

At step 250, the processing system forwards (e.g., receives and re-transmits) data traffic for at least one endpoint device via the fronthaul connection and via at least a second wireless link between the non-terrestrial network node and the at least one endpoint device (e.g., uplink and/or downlink data traffic). In addition, in an example, in which two or more BBUs are selected at step 230, step 250 may include forwarding data traffic for at least one endpoint device via the two or more fronthaul connections and via the at least the second wireless link between the NTN node and the at least one endpoint device. In one example, the processing system may even split data traffic for one endpoint device, e.g., different paths for uplink and downlink and/or for different applications, etc. Alternatively, or in addition, data traffic for different endpoint devices may be routed via different BBUs.

At optional step 260, the processing system may drop a second fronthaul connection after the fronthaul connection is established at step 240. For instance, as noted above, in some cases, a prior BBU association may be released. In addition, in some cases, the fronthaul and/or the feeder link thereof may no longer be required to be maintained (or may be not possible to maintain, such as due to NTN node movement).

Following step 250 or optional step 260, the method 200 proceeds to step 295 where the method 200 ends.

It should be noted that the method 200 may be expanded to include additional steps or may be modified to include additional operations with respect to the steps outlined above. For example, the method 200 may be repeated on an ongoing basis to perform steps 220-250, steps 210-250, etc. In one example, the method 200 may be expanded to further include collecting labels/feedback from endpoint devices and/or performance data from network components for sample labeling and for MLM training/retraining, and so forth. In one example, the method 200 may be expanded or modified to include steps, functions, and/or operations, or other features described in connection with the example(s) of FIG. 1, or as described elsewhere herein. Thus, these and other modifications are all contemplated within the scope of the present disclosure.

In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. For example, any one or more components or devices illustrated in FIG. 1 or described in connection with the example method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for establishing a fronthaul connection between a non-terrestrial network node and a first baseband unit that is selected from among a plurality of available baseband units via a machine learning model implemented by the non-terrestrial network node, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 306 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for establishing a fronthaul connection between a non-terrestrial network node and a first baseband unit that is selected from among a plurality of available baseband units via a machine learning model implemented by the non-terrestrial network node (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for establishing a fronthaul connection between a non-terrestrial network node and a first baseband unit that is selected from among a plurality of available baseband units via a machine learning model implemented by the non-terrestrial network node (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
identifying, by a processing system including at least one processor of a non-terrestrial network node, a plurality of available baseband units of a cellular network;
selecting, by the processing system, a first baseband unit from among the plurality of available baseband units via a machine learning model implemented by the processing system;
establishing, by the processing system, a fronthaul connection between the non-terrestrial network node and the first baseband unit, wherein the fronthaul connection is via a first wireless link between the non-terrestrial network node and the first baseband unit; and
forwarding, by the processing system, data traffic for at least one endpoint device via the fronthaul connection and via at least a second wireless link between the non-terrestrial network node and the at least one endpoint device.

2. The method of claim 1, wherein the first baseband unit comprises a centralized unit and a distributed unit.

3. The method of claim 2, wherein the centralized unit and the distributed unit comprise at least a portion of a cellular base station.

4. The method of claim 2, wherein the non-terrestrial network node comprises a radio unit.

5. The method of claim 4, wherein the centralized unit, the distributed unit, and the radio unit comprise a disaggregated cellular base station.

6. The method of claim 1, wherein the fronthaul connection includes a wireless feeder link between the non-terrestrial network node and a satellite ground station.

7. The method of claim 6, wherein the fronthaul connection further includes a terrestrial communication link between the first baseband unit and the satellite ground station.

8. The method of claim 1, wherein the fronthaul connection is in accordance with an open radio access network fronthaul protocol.

9. The method of claim 1, wherein the first baseband unit is deployed in a second non-terrestrial network node.

10. The method of claim 1, wherein the machine learning model comprises a language model.

11. The method of claim 1, wherein the machine learning model is configured to generate an output comprising a selected baseband unit in response to an input vector comprising load information associated with the plurality of available baseband units.

12. The method of claim 11, further comprising:
configuring the machine learning model, wherein the configuring comprises:
training the machine learning model with labeled examples; or
fine tuning the machine learning model with the load information.

13. The method of claim 12, wherein the load information is obtained from a second baseband unit via a second fronthaul connection with the non-terrestrial network node.

14. The method of claim 12, wherein the load information comprises one or more of:
a number of non-terrestrial network nodes attached to each of the plurality of available baseband units;
a number of endpoint devices being served via each of the plurality of available baseband units;
a data traffic volume via each of the plurality of available baseband unit; or
a remaining available capacity of each of the plurality of available baseband units.

15. The method of claim 13, wherein the input vector further comprises one or more of:
load information of the non-terrestrial network node;
a trajectory of the non-terrestrial network node;
locations of one or more satellite ground stations;
latencies between the one or more satellite ground stations and respective ones of the plurality of available baseband units; or
distances between the one or more satellite ground stations and the respective ones of the plurality of available baseband units.

16. The method of claim 1, wherein the selecting comprises selecting two or more baseband units including the first baseband unit from among the plurality of available baseband units via the machine learning model.

17. The method of claim 1, wherein the non-terrestrial network node comprises:
a satellite;
a low earth orbit satellite; or
an uncrewed aerial vehicle.

18. The method of claim 1, wherein the plurality of available baseband units includes a baseband unit that is a component of the non-terrestrial network node.

19. A non-transitory computer-readable medium storing instructions which, when executed by a processing system including at least one processor deployed in a non-terrestrial network node, cause the processing system to perform operations, the operations comprising:
identifying a plurality of available baseband units of a cellular network;
selecting a first baseband unit from among the plurality of available baseband units via a machine learning model implemented by the processing system;
establishing a fronthaul connection between the non-terrestrial network node and the first baseband unit, wherein the fronthaul connection is via a first wireless link between the non-terrestrial network node and the first baseband unit; and
forwarding data traffic for at least one endpoint device via the fronthaul connection and via at least a second wireless link between the non-terrestrial network node and the at least one endpoint device.

20. An apparatus comprising:
a processing system including at least one processor; and
a non-transitory computer-readable medium storing instructions which, when executed by the processing system when deployed in a non-terrestrial network node, cause the processing system to perform operations, the operations comprising:
identifying a plurality of available baseband units of a cellular network;
selecting a first baseband unit from among the plurality of available baseband units via a machine learning model implemented by the processing system;
establishing a fronthaul connection between the non-terrestrial network node and the first baseband unit, wherein the fronthaul connection is via a first wireless link between the non-terrestrial network node and the first baseband unit; and
forwarding data traffic for at least one endpoint device via the fronthaul connection and via at least a second wireless link between the non-terrestrial network node and the at least one endpoint device.
